(19) United States
(12) Patent Application Publication
(10) Pub. No.: US 2003/0214181 A1
(43) Pub. Date: Nov. 20, 2003

(54) Traction control system including automatic engine torque increase during mu-split starting operations

(76) Inventor: Norbert Polzin, Zaberfeld (DE)

Correspondence Address: KENYON & KENYON, ONE BROADWAY, NEW YORK, NY, 10004, US

(21) Appl. No.: 10/401,064

(22) Filed: Mar. 27, 2003

(30) Foreign Application Priority Data
Mar. 27, 2002 (DE) 102 13 665.3
Aug. 21, 2002 (DE) 102 38 219.0

(51) Int. Cl. B60T 8/60

(52) U.S. Cl. 303/142; 303/149

(57) ABSTRACT

A traction control system including engine intervention and brake intervention, during a start under μ-split conditions the engine torque is increased compared to the driver input to accelerate vehicles as under high friction conditions, the vehicle acceleration under high friction conditions is determined, and engine torque is further increased by the brake torque applied to the low-μ wheel.

### FIELD OF THE INVENTION

The present invention relates to a traction control system (TCS) and method including engine intervention and brake intervention.

### BACKGROUND OF THE INVENTION

Due to road surface conditions, the tires of a vehicle may experience differing adhesions between the left side and the right side (μ-split). To better control the traction when starting a vehicle under such a condition, the driven wheel on the slippery road side (low-μ wheel) is slowed as it starts to spin. The brake torque applied to the low-μ wheel is then transmitted to the wheel on the skid resisting road side (high-μ wheel) via the differential and may be used there for propulsion of the vehicle.

During such starting operations, the engine torque in the brake is converted into heat due to the above-mentioned brake intervention at the slipping wheel. Thus, the driver must apply more engine torque than he is used to applying for the same acceleration during a starting operation on a high friction road surface. If, however, the driver applies little gas during starting on μ-split road surfaces, the engine may stall due to the brake intervention, in particular during the start on uphill grades.

### SUMMARY OF THE INVENTION

According to an embodiment of the present invention, acceleration behavior of a vehicle under μ-split is improved by increasing the engine torque during a starting phase so that, during the start on a road surface of differing adhesions between the left side and the right side of the vehicle (μ-split), the vehicle accelerates with essentially the same acceleration as under high friction conditions. In order to calculate the engine torque required here, the vehicle acceleration, which would occur under high friction conditions (without wheel slip) for the accelerator pedal position selected by the driver, is determined. Based upon the acceleration determined, an engine torque is finally calculated which, compared to the driver input, is increased at least by the brake torque applied to the low-μ wheel. Due to this adjustment of the engine torque, the vehicle accelerates on a road surface of differing adhesions the same way as under normal high friction conditions.

According to an embodiment of the present invention, the vehicle acceleration under high friction conditions is read out from a characteristic curve or a table stored in the traction control system.

Due to this automatic engine torque increase, the vehicle thus responds in an accustomed manner, even on a road surface of differing adhesions between the left side and the right side of the vehicle. By pressing the accelerator pedal only a little, the driver is now able to slowly accelerate without the risk of stalling the engine.

The following equation for the driving power may be applied for calculating the engine torque:

Fan=Fhang+Froll+Fbrems+Fvor,

where

Fan: propulsion power;

Fhang=m*g*sin α, slope downforce;

Froll=m*g*cos α*fr, fr=0.015, rolling resistance force;

Fbrems: braking force on the low-μ wheel; and

Fvor: propulsion force.

The required propulsion torque Man is obtained from the following:

Man=(m*g*sin α+fr*m*g*cos α)*r_{dyn}+Mbrems+m*a*r_{dyn}

where

r_{dyn}: dynamic wheel radius.

The required engine torque Mmot is obtained from:

Mmot=Man/Igesamt*eta, where

Man: propulsion torque;

Igesamt: overall gear ratio;

eta: overall efficiency

The acceleration a_{grenz} under high friction conditions on a flat surface (without brake intervention) may be calculated for example from the following relationship, taking into account the driver input. For minor gradients a the following applies approximately:

Mmot=(fr*m*g*r_{dyn}+m*a_{grenz}*r_{dyn})/Igesamt*eta.

The acceleration value a_{grenz} may optionally be read out from a corresponding characteristic curve or a table which is already stored in the traction control system.

In order to obtain the same acceleration value a_{grenz} on a μ-split road surface as under high friction conditions, the following engine torque Mmot is set:

Mmot=(fr*m*g*r_{dyn}+m*a_{grenz}*r_{dyn}+Mbrems)/Igesamt*eta

The engine torque Mmot is thus increased by: Mbrems/Igesamt*eta.

During a starting operation on a μ-split uphill gradient, the slope downforce has to be additionally compensated in order to obtain the same acceleration values a_{grenz} as on a flat surface. In this case the following applies (neglecting the rolling resistance):

Mmot=(m*g*sin α*r_{dyn}+Mbrems+m*a_{grenz}*r_{dyn})/Igesamt*eta.

Engine torque Mmot is thus increased by (Mbrems+m*g*sin α*r_{dyn})/Igesamt*eta in order to obtain the same acceleration as on a flat surface at high friction. In order to achieve the same acceleration as during uphill travel at high friction, a corresponding acceleration a_{grenz}_{_{—}}_{Hang} is applied for the slope instead of the acceleration a_{grenz} for a flat surface.

The slope of the roadway (angle α), i.e., the slope downforce torque, may be determined by using a particular sensor, an inclination sensor, or an acceleration sensor for example, or it may be estimated on the basis of brake pressure values.

However, even in a traction control system without an inclination sensor, or without considering the slope, the compensation of the braking torque Mbrems already results in a noticeable improvement of the traction. In this case, the vehicle is accelerated approximately as it is under optimum traction on a flat surface or on the slope.

In contrast, by compensating the slope downforce torque Mhang, the vehicle acts during a start on a μ-split slope in the same way as on a flat surface under high friction conditions. Therefore, the driver does not have to change his starting habit for an uphill start, but rather may accelerate in the same way as habitually by applying relatively little gas.

According to a preferred embodiment of the present invention, the automatic increase of the engine torque is limited to a specified lower speed range, in particular a speed range of under 30 km/h.

For reasons of comfort, the increase in the engine torque is preferably not executed suddenly but rather within a specified time period. For example, the increase of the engine torque may be executed by using a specified gradient; the gradient may be a function of vehicle speed v, engine speed n_mot, or of another variable. The following relationship applies: gradient=f(v,n_mot, . . . ).

### BRIEF DESCRIPTION OF THE DRAWINGS

FIG. 1 shows a traction control system which is able to automatically increase the engine torque during μ-split starting operations.

FIG. 2 shows a flow chart for explaining a method of traction control according to one embodiment of the present invention.

### DETAILED DESCRIPTION

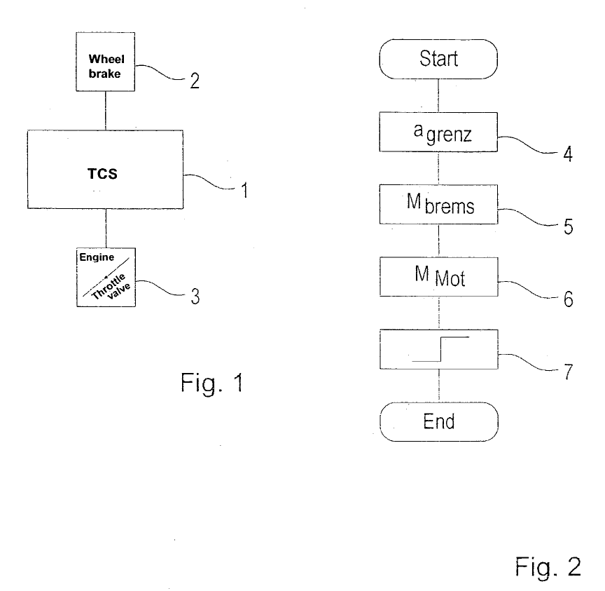

FIG. 1 shows a traction control system including a central TCS unit 1 which, when specified slip thresholds for a driven wheel are exceeded, cooperates with a wheel brake 2 and with engine 3 (the throttle valve) and which intervenes regulating the driving operation.

The traction control system is designed such that the engine torque is automatically increased during a starting phase when a driven wheel of the vehicle starts to slip on a road surface of differing adhesions. The increase in the engine torque takes place here to the extent that the vehicle essentially accelerates with the same acceleration as under high friction conditions. For this purpose, compared to the driver input, the engine torque is increased by at least the braking torque applied to the low-μ wheel.

FIG. 2 shows the procedure of such an engine torque increase in the form of a flow chart. First, acceleration a_{grenz} with which the vehicle would accelerate at the selected driver input under high friction conditions is determined in step 4. Subsequently in step 5, the braking torque applied to the low-μ wheel is determined, and, in step 6, a new engine torque is calculated based upon the determined acceleration a_{grenz} and the determined braking torque M_{brems}. The new engine torque calculated in such a manner is finally set on engine 3. According to one embodiment of the present invention, the increase in the engine torque in step 7 takes place by using a specified gradient (not suddenly).

What is claimed is:

1. A traction control system providing an engine intervention and a brake intervention for a vehicle, comprising:
an arrangement for automatically increasing, during a starting phase, an engine torque in such a way that the vehicle, during a start on a road surface of differing adhesions between a left side and a right side of the vehicle, accelerates with essentially the same acceleration as under a high friction condition, wherein:
the engine torque, compared to a driver input, is increased by at least a braking torque applied to the low-μ wheel.

2. The traction control system as recited in claim 1, wherein:
the vehicle includes a motor vehicle.

3. The traction control system as recited in claim 1,further comprising:
an arrangement for reading out from one of a characteristic curve and a table an acceleration corresponding to the high friction condition taking into consideration the driver input.

4. The traction control system as recited in claim 1, further comprising:
an arrangement for determining a slope downforce torque acting during an uphill start; and
an arrangement for increasing the engine torque by a corresponding value of the slope downforce torque.

5. The traction control system as recited in claim 1, further comprising:
an arrangement for setting the engine torque such that the vehicle, during an uphill start, accelerates with essentially the same acceleration as under the high friction condition on a flat surface.

6. The traction control system as recited in claim 1, wherein:
an increase in the engine torque is limited to a specified lower speed range.

7. The traction control system as recited in claim 1, wherein:
an increase in the engine torque takes place within a specified time period.

8. The traction control system as recited in claim 1, wherein:
an increase in the engine torque is executed by using a specified gradient as a function of one of a vehicle speed and an engine speed.

9. A method of traction control providing an engine intervention and a brake intervention to start a vehicle on a road surface of differing adhesions between a left side and a right side of the vehicle, comprising:
determining an acceleration with which the vehicle, at a given driver input, would accelerate under a high friction condition;
determining a brake torque applied to a low-μ wheel;
calculating an engine torque based upon the acceleration and the brake torque; and
setting at least the calculated engine torque.

10. The method as recited in claim 9, wherein:
the acceleration is determined during an uphill start with which the vehicle, at the given driver input, would accelerate on a flat surface under the high friction condition.

11. The method as recited in claim 9, further comprising:
determining a slope downforce torque during an uphill start; and
increasing the engine torque by a value of the slope downforce torque.
